(19) United States
(12) Patent Application Publication
(10) Pub. No.: US 2026/0170268 A1
(43) Pub. Date: Jun. 18, 2026

(54) QUESTION ANSWERING DEVICE AND QUESTION ANSWERING METHOD

(71) Applicant: Hitachi, Ltd., Tokyo (JP)

(72) Inventors: Yuichi KITAGAWA, Tokyo (JP); Taichi HISATSUNE, Tokyo (JP); Takahito TANIMURA, Tokyo (JP); Masayuki TAKASE, Tokyo (JP); Kazuhisa UCHIYAMA, Tokyo (JP); Takahiro SUZUKI, Tokyo (JP); Tatsuya ISHIZAKA, Tokyo (JP)

(73) Assignee: Hitachi, Ltd., Tokyo (JP)

(21) Appl. No.: 19/304,865

(22) Filed: Aug. 20, 2025

(30) Foreign Application Priority Data
Dec. 12, 2024 (JP) 2024-217684

(51) Int. Cl. G06F 40/40

(52) U.S. Cl. CPC G06F 40/40

(57) ABSTRACT

A question answering device includes a hardware processor that is configured to refer to answering support information in which a question and an answer to the question are stored in association with each other, and output the answer corresponding to the question that is in the answering support information and whose level of similarity to a user issued question is greater than or equal to a first predetermined similarity level, as an answer to the user issued question.

### CROSS-REFERENCE TO RELATED APPLICATION

The present application is based on, and claims priority from, Japan Application Serial Number 2024-217684, filed Dec. 12, 2024, the disclosure of which is hereby incorporated by reference herein in its entirety.

### BACKGROUND OF THE INVENTION

### Technical Field

The disclosure relates to a question answering device and a question answering method which use a language model.

### Related Art

Introduction of a chatbot that automatically answers a question of a client has in recent years become common in client support operations. Questions from clients and answers to the questions are accumulated and compiled as a frequently asked questions list (an FAQ, a list of questions and answers) that is used for improving the quality of answers of the chatbot.

As a technology of answering questions from clients, there is an information processing device described in Japanese Unexamined Patent Application Publication No. 2024-021725. This information processing device includes an extraction unit that extracts questions and answers from documents. In addition, the information processing device includes a search unit that searches the documents and the extracted questions and answers by using a search query received from a user. Further, the information processing device includes a display control unit that displays a document searched for by the search unit, and conducts control to display the question and the answer searched for by the search unit in association with the document from which the question and the answer are extracted.

The information processing device described in Japanese Unexamined Patent Application Publication No. 2024-021725 extracts questions and answers (an FAQ) by extracting sentences in forms of a question sentence or an answer sentence from a document, and outputs an answer having a relatively high search score from the extracted FAQ. For this reason, there is a case where, if the score is high among the extracted FAQ, an answer is output even when the answer deviates from a search query (question).

### SUMMARY OF THE INVENTION

An embodiment of the disclosure provides a question answering device that includes a hardware processor. The hardware processor is configured to refer to answering support information in which a question and an answer to the question are stored in association with each other. Further, the hardware processor is configured to output the answer corresponding to the question that is in the answering support information and whose level of similarity to a user issued question is greater than or equal to a first predetermined similarity level, as an answer to the user issued question. The user issued question is a question issued by a user.

### BRIEF DESCRIPTION OF DRAWINGS

FIG. 1 is a functional block diagram of a question answering device according to an embodiment.

FIG. 2 is a data configuration diagram of an answering support information database according to an embodiment.

FIG. 3 is a data configuration diagram of a user evaluation cache according to an embodiment.

FIG. 4 is a diagram showing an administrator screen according to an embodiment.

FIG. 5 is a flowchart of a starting process according to an embodiment.

FIG. 6 is a diagram showing a question answer generating prompt according to an embodiment.

FIG. 7 is a flowchart of a question answering process according to an embodiment.

FIG. 8 is a diagram showing a user screen according to an embodiment.

FIG. 9 is a flowchart of an answer acquiring process according to an embodiment.

FIG. 10 is a diagram showing an answer generating prompt according to an embodiment.

FIG. 11 is a flowchart of a user evaluation process according to an embodiment.

FIG. 12 is a flowchart of an answering support information updating process according to an embodiment.

FIG. 13 is a diagram showing an answer regenerating prompt according to an embodiment.

FIG. 14 is a diagram showing a question answer adding prompt according to an embodiment.

FIG. 15 is a hardware configuration diagram showing an example of a computer that achieves functions of the question answering device according to an embodiment.

### DETAILED DESCRIPTION

### Overview of Question Answering Device

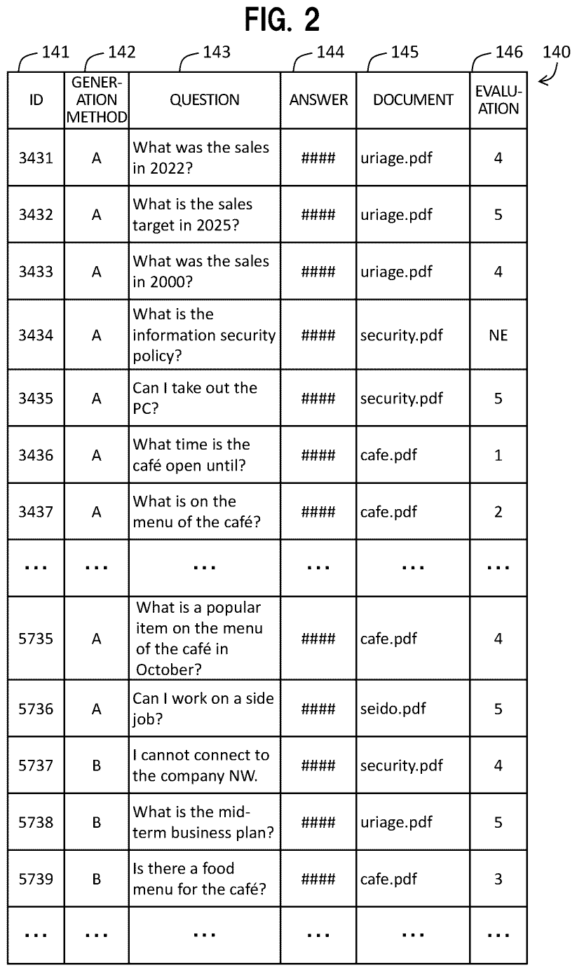

Hereinafter, an overview of a question answering device in a mode for carrying out the disclosure (an embodiment) will be described. The question answering device stores a result of extracting, from a document, a question and an answer relating to content of the document as answering support information together with the document, which is the extraction source (see an answering support information database 140 of FIG. 2, which will be described later). Upon receipt of a question from a user, when there is a question in the answering support information whose level of similarity to the question from the user is greater than or equal to a first predetermined similarity level, the question answering device returns an answer to the question to the user. In a case where there is no question in the answering support information whose level of similarity is greater than or equal to the first predetermined similarity level, the question answering device generates an answer based on the document by using a language model server, and returns the generated answer to the user. Note that the first predetermined similarity level is a very high similarity level that may be sufficient to consider that the contents of the questions coincide with each other.

The question answering device may store an evaluation value that is provided by the user for an answer in the answering support information. In this case, when there is a question in the answering support information whose level of similarity is greater than or equal to the first predetermined similarity level and an evaluation value is greater than or equal to a predetermined evaluation value, the question answering device may return an answer to the question to a user.

In a case where there is no question whose level of similarity is greater than or equal to the first predetermined similarity level and whose evaluation value is greater than or equal to the predetermined evaluation value, the question answering device may use the language model server to generate an answer based on an extraction source document of a question whose level of similarity is greater than or equal to a second predetermined similarity level and whose evaluation value is greater than or equal to the predetermined evaluation value. In a case where there is no such a question, the question answering device may use the language model server to generate an answer based on a document that is similar to a question issued by the user (a user issued question). Note that the second predetermined similarity level is lower than the first predetermined similarity level.

According to such a question answering device, the user may obtain a highly accurate answer to a question. It is expected that an accuracy of an answer may be improved by generating a new answer in accordance with the level of similarity of a question and the evaluation value on an answer.

### Configuration of Question Answering Device

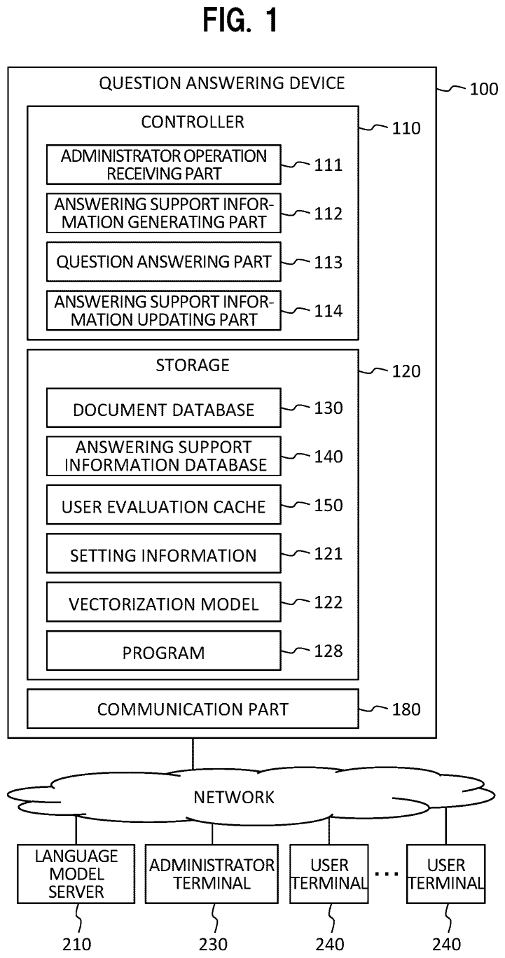

FIG. 1 is a functional block diagram of a question answering device 100 according to the present embodiment. The question answering device 100 is a computer and includes a controller 110, a storage 120, and a communication part 180. The communication part 180 includes a communication device and is capable of transmitting and receiving data to and from a language model server 210, an administrator terminal 230, and a user terminal 240.

The question answering device 100 transmits a prompt that includes a question or an instruction described in a text (linguistic information) to the language model server 210. The language model server 210 replies to the question answering device 100 by generating an answer to the prompt by using a language model (for example, a large language model).

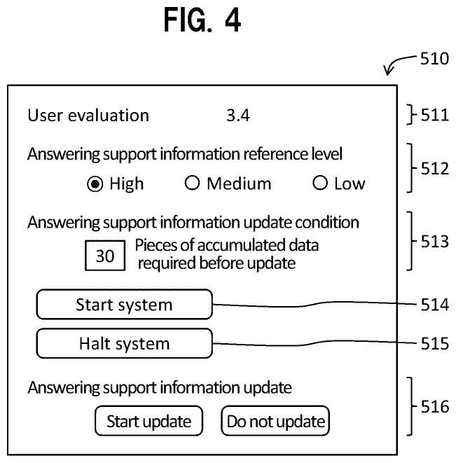

The administrator terminal 230 is a terminal used by an administrator of the question answering device 100. By using an administrator screen 510 (see FIG. 4, which will be described later), the administrator instructs a setting of the question answering device 100 or an updating of the answering support information.

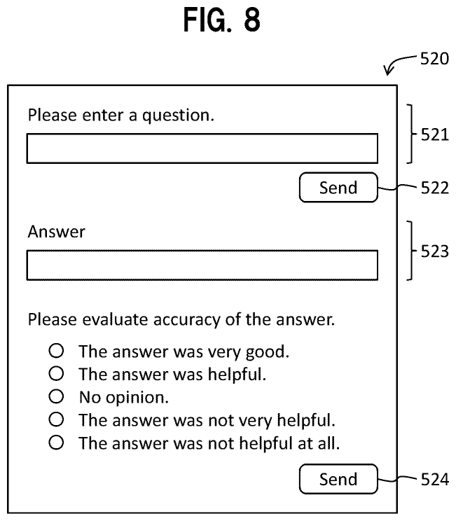

The user terminal 240 is a terminal used by a user (questioner) of the question answering device 100. The user asks a question to the question answering device 100 by using a user screen 520 (see FIG. 8, which will be described later). In addition, the user evaluates an answer to a question by using the user screen 520.

### Question Answering Device: Storage

The storage 120 is configured to include a storage device such as a read only memory (ROM), a random access memory (RAM), or a solid state drive (SSD). The storage 120 stores therein a document database 130, an answering support information database 140, a user evaluation cache 150, a setting information 121, a vectorization model 122, and a program 128. The program 128 includes descriptions of processes that are executed by functional parts included in the controller 110, which will be described later. Note that various contents stored in the storage 120 may be loaded from those stored in an external storage device such as a cloud server as necessary.

### Storage: Document Database

The document database 130 includes documents, based on which an answer to a question from a user is created. In other words, a content of a question to be answered by the question answering device 100 is a content of a document in the document database 130.

### Storage: Answering Support Information Database

FIG. 2 is a data configuration diagram of the answering support information database 140 according to the present embodiment. For example, the answering support information database 140 is data in a tabular format, and one row (a record) indicates a question and an answer. More specifically, each record includes columns (attributes) of identification information 141, a generation method 142, a question 143, an answer 144, a document 145, and an evaluation 146.

The identification information 141 (described as “ID” in FIG. 2) is identification information of the record. The identification information may be considered as identification information of the question.

The generation method 142 refers to a method of generation of the record and may be “A” or “B”. “A” indicates that the record is a record generated by an answering support information generating part 112 (to be described later) or an answering support information updating part 114 (to be described later). The record of “A” is a record which has been in the answering support information database 140 before reception of a question from a user. “B” indicates that the record is a record generated by a question answering part 113 (to be described later). The record of “B” is a record including an answer that has been generated in response to a question from a user.

A relation between the question 143, the answer 144, and the document 145 is that the question 143 and the answer 144 is related to the content of a document indicated by the document 145 (a name or identification information of the document).

The evaluation 146 is an evaluation on answer accuracy by the user for the answer 144. The evaluation 146 may, for example, be on a 5 point scale ranging from 1 to 5 (see FIG. 8, which will be described later), and the higher the evaluation 146 is, the higher the evaluation is. “NE” (an abbreviation for “not evaluated”) indicates that the question has not been received from the user and the answer has not been evaluated. Note that an evaluation may also be described as a user evaluation.

As described above, in the answering support information (see the answering support information database 140), an evaluation value (see the evaluation 146) provided by the user on the answer 144 is associated and stored.

In the answering support information, the document 145 relating to the question 143 is associated and stored.

### Storage: User Evaluation Cache

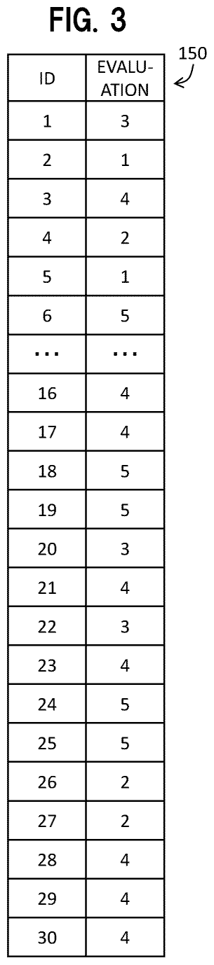

FIG. 3 is a data configuration diagram of the user evaluation cache 150 according to the present embodiment. In the user evaluation cache 150, a predetermined number of latest user evaluations are stored. The predetermined number is a size of the user evaluation cache 150 that is set by the administrator (see region 513 of FIG. 4, which will be described later).

### Storage: Setting Information

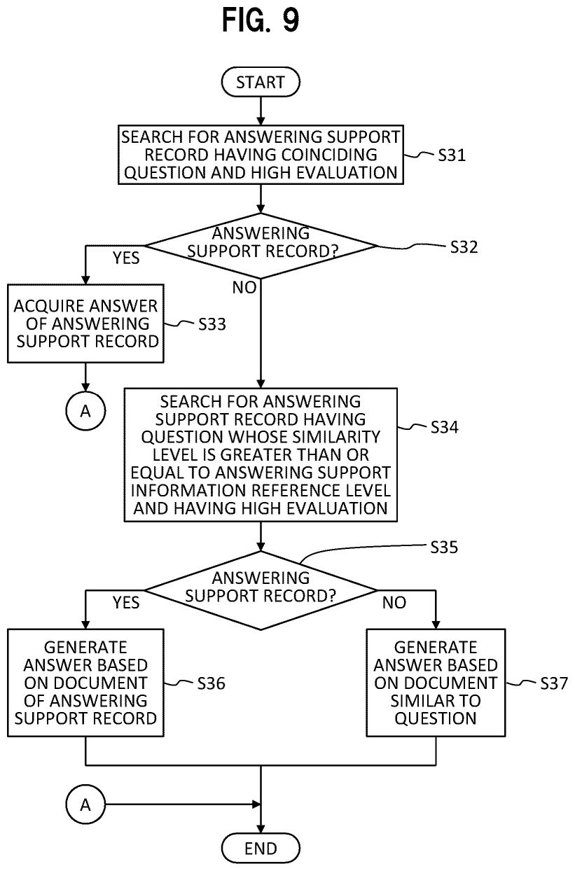

Returning to FIG. 1, description of the storage 120 will be continued. In the setting information 121, a setting relating to the question answering device 100, which is set by the administrator, is stored. The setting information 121 may include, in addition to the size of the user evaluation cache 150 (see FIG. 3), a setting value relating to the user evaluation or a level of similarity of questions that is referenced in an answer acquiring process (see FIG. 9), which will be described later, or the like.

### Storage: Vectorization Model

The vectorization model 122 is a machine learning model used in converting a text (linguistic information) to a (numerical value) vector. An input of the vectorization model 122 (explanatory variable) is a text, and an output thereof (target variable) is a vector. Texts that are similar in content are converted to similar vectors. Note that a level of similarity of vectors is calculated as a cosine similarity. In the following description of the embodiment, the level of similarity between texts, such questions or a question and a document, is a cosine similarity of vectors after the texts have been converted by using the vectorization model 122.

### Question Answering Device: Controller

The controller 110 is configured to include a central processing unit (CPU), and includes an administrator operation receiving part 111, the answering support information generating part 112, the question answering part 113, and the answering support information updating part 114. In one or more embodiments, the controller 110 may be configured to include a graphics processing unit (GPU), a neural (network) processing unit (NPU), a field programmable gate array (FPGA), an application specific integrated circuit (ASIC), or the like.

### Controller: Administrator Operation Receiving Part

The administrator operation receiving part 111 receives a setting and an operation for the question answering device 100 via the administrator screen 510 (see FIG. 4), which will be described later. FIG. 4 is a diagram showing the administrator screen 510 according to the present embodiment. The administrator screen 510 is displayed on the administrator terminal 230 used by the administrator.

In a region 511 of the administrator screen 510, an average value of latest user evaluations in the user evaluation cache 150 (see FIG. 3) is shown.

In a region 512, an answering support information reference level (second predetermined similarity level) referenced in an answer acquiring process (see FIG. 9), which will be described later, is set. The answering support information reference level is a threshold value relating to a level of similarity between a question issued by a user and a question 143 in the answering support information database 140 (see FIG. 2). In a case where there is no question in the answering support information database 140 whose level of similarity to the question issued by the user is greater than or equal to a level of similarity indicated by the answering support information reference level, an answer is newly generated (see step S37 of FIG. 9, which will be described later). The level of similarity indicated by the answering support information reference level is 0.9 for high, 0.8 for medium, and 0.7 for low, for example. Note that the answering support information reference level (second predetermined similarity level) is a value that is lower (smaller) than the first predetermined similarity level.

In a region 513, a size of the user evaluation cache 150 (see FIG. 3) is set.

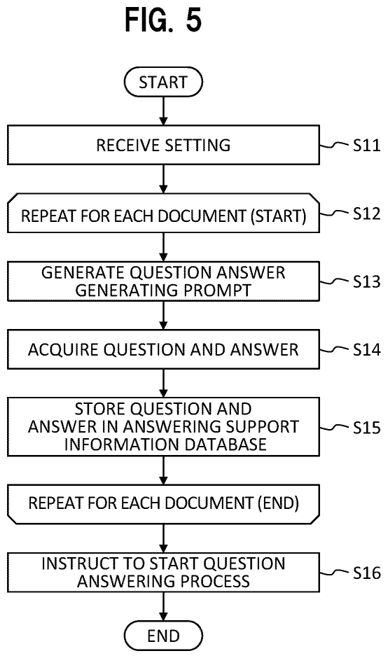

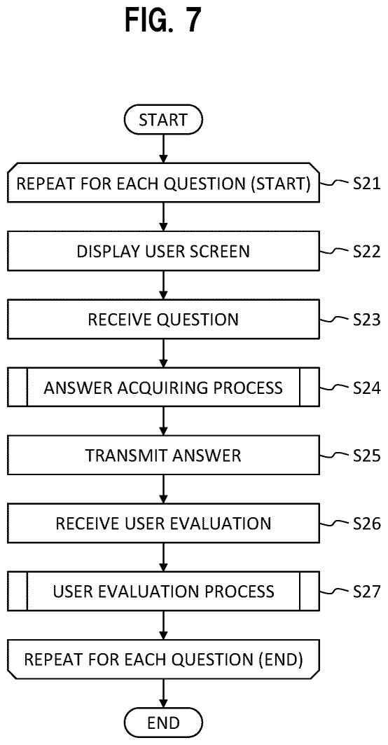

When a “Start system” button 514 is pressed, the administrator operation receiving part 111 executes a starting process (see FIG. 5, which will be described later). After the starting process, the question answering device 100 executes a question answering process (see FIG. 7, which will be described later) to receive a question of the user and answer the question.

When a “Halt system” button 515 is pressed, the administrator operation receiving part 111 halts the question answering process.

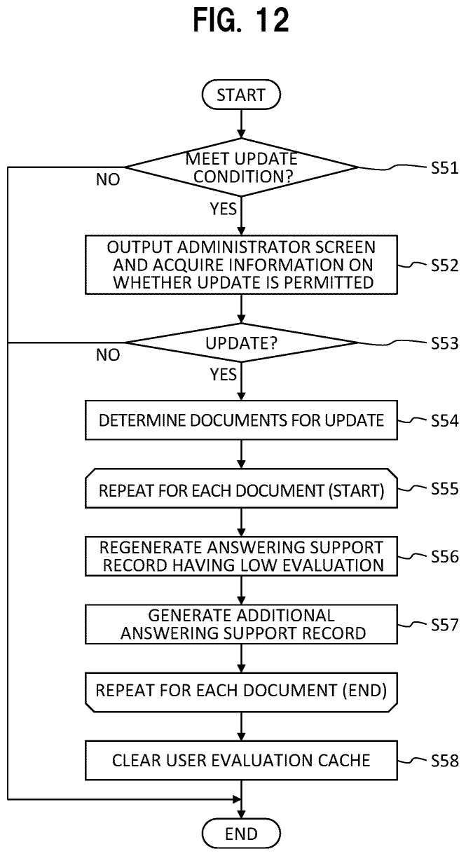

In a region 516, an instruction may be provided on whether or not to permit an update of the answering support information database 140. More specifically, when a “Start update” button is pressed, the answering support information updating part 114, which will be described later, starts an answering support information updating process (see FIG. 12, which will be described later).

### Controller: Answering Support Information Generating Part, Question Answering Part, and Answering Support Information Updating Part

The answering support information generating part 112 generates (constructs) the answering support information database 140 based on documents in the document database 130. Details of the generating process (see FIG. 5) will be described later.

The question answering part 113 answers the question issued by the user. Details of the answering process (see FIG. 7) will be described later.

The answering support information updating part 114 updates the answering support information database 140. Details of the updating process (see FIG. 12) will be described later.

### Starting Process (Answering Support Information Generating Process)

FIG. 5 is a flowchart of the starting process according to the present embodiment. The starting process includes an answering support information generating process. With reference to FIG. 5, the starting process after the “Start system” button 514 (see FIG. 4) is pressed will be described. The starting process is a process of a preparation stage and is a process that is executed before the question answering device 100 receives and answers a question from a user.

In step S11, the administrator operation receiving part 111 receives the settings of the answering support information reference level (see region 512 shown in FIG. 4) and the size of the user evaluation cache 150 (see region 513 shown in FIG. 4). The administrator operation receiving part 111 stores the settings in the setting information 121.

In step S12, the answering support information generating part 112 starts a process of repeating steps S13 to S15 for each document in the document database 130. Hereinafter, a document to be processed in the repeated process will be referred to as a processing target document. A processing target may not have to be each document, but may be a chapter or a section contained in a document.

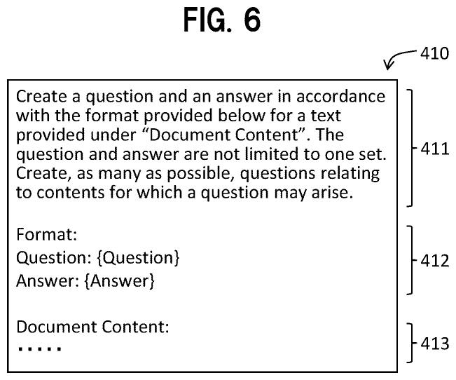

In step S13, the answering support information generating part 112 generates a question answer generating prompt 410 (see FIG. 6, which will be described later). FIG. 6 is a diagram showing the question answer generating prompt 410 according to the present embodiment. An element 411 of the question answer generating prompt 410 contains an instruction to create a question and an answer in accordance with a format in an element 412, based on document content in an element 413. The element 412 shows the format in which a question and an answer are outputted in separate rows. The element 413 shows processing target document.

Returning to FIG. 5, description of the starting process will be continued.

In step S14, the answering support information generating part 112 transmits the question answer generating prompt 410 to the language model server 210 and acquires a question and an answer.

In step S15, the answering support information generating part 112 stores the question and the answer acquired in step S14 in the answering support information database 140. More specifically, the answering support information generating part 112 adds a record to the answering support information database 140, and stores the question and the answer acquired in step S14 and new identification information in the record. In addition, the answering support information generating part 112 stores a name or identification information of the processing target document as the document 145 and sets the evaluation 146 to “NE”.

In step S16, the administrator operation receiving part 111 instructs the question answering part 113 to start the question answering process (see FIG. 7, which will be described later).

Note that the processing steps from S12 to S15 may also be referred to as an answering support information generating process. At the time when the answering support information generating process ends, the generation method 142 and the evaluation 146 for records in the answering support information database 140 are “A” and “NE” respectively.

### Question Answering Process

FIG. 7 is a flowchart of the question answering process according to the present embodiment. A process in which the question answering device 100 receives a question from the user and answers the question will be described with reference to FIG. 7.

In step S21, the question answering part 113 starts a process of repeating steps S22 to S27.

In step S22, the question answering part 113 displays the user screen 520(see FIG. 8, which will be described later) on the user terminal 240. FIG. 8 is a diagram showing the user screen 520 according to the present embodiment. When the user enters a question in a text box in a region 521 and presses a “Send” button 522, the user terminal 240 transmits the entered question to the question answering device 100.

Returning to FIG. 7, description of the question answering process will be continued.

In step S23, the question answering part 113 receives the question transmitted by the user terminal 240.

In step S24, the question answering part 113 executes the answer acquiring process (see FIG. 9, which will be described later) to acquire an answer to the question.

In step S25, the question answering part 113 transmits the answer acquired in step S24 to the user terminal 240. Upon receipt of the answer, the user terminal 240 displays the answer in a text box of a region 523 of the user screen 520 (see FIG. 8). The user evaluates the answer accuracy, selects a result of the evaluation, and presses a “Send” button 524. Then, the user terminal 240 transmits the result of the evaluation (hereinafter, the result of the evaluation may also be referred to as evaluation or user evaluation) to the question answering device 100. Note that the result of evaluation may range from “The answer was very good.”, indicating that the evaluation is 5, which is the highest, to “The answer was not helpful at all.”, indicating that the evaluation is 1, which is the lowest.

In step S26, the question answering part 113 receives the evaluation transmitted by the user terminal 240.

In step S27, the question answering part 113 executes a user evaluation process (see FIG. 11, which will be described later) to store the evaluation in the answering support information database 140 (see FIG. 2).

### Answer Acquiring Process

FIG. 9 is a flowchart of the answer acquiring process according to the present embodiment. Details of the answer acquiring process (see step S24 described in FIG. 7) of acquiring an answer to the question issued by the user will be described with reference to FIG. 9.

In step S31, the question answering part 113 searches for a record (described as an “answering support record” in FIG. 9) including a question 143 that coincides with the question issued by the user and a high evaluation 146 from the records of the answering support information database 140 (see FIG. 2). The high evaluation 146 means that the evaluation 146 is greater than or equal to the predetermined evaluation value, which is a predetermined threshold value. Note that in a case where the evaluation 146 is “NE”, the evaluation may be considered as being high. In the present embodiment, the predetermined evaluation value is, for example, 4.

The coincidence between the question 143 of a record and the question issued by the user means that the level of similarity is greater than or equal to a predetermined high threshold value. In the present embodiment, the question 143 of a record and the question issued by the user may be considered to coincide when the level of similarity between the question 143 of the record and the question issued by the user is greater than or equal to the first predetermined similarity level. The first predetermined similarity level is, for example, 0.98. Note that the level of similarity between two texts, such as two questions or a question and a document, is a cosine similarity of vectors obtained by converting the texts by using the vectorization model 122 (see the vectorization model 122).

If a record is found in step S31 (step S32->YES), in step S32, the question answering part 113 advances the process to step S33. If no record is found (step S32->NO), the question answering part 113 advances the process to step S34.

In step S33, the question answering part 113 ends the answer acquiring process with the answer 144 of the record found in step S31 as a result of the process.

In step S34, the question answering part 113 searches for a record that includes a question 143 whose level similarity to the question issued by the user is greater than or equal to the answering support information reference level and includes a high evaluation 146 from the records of the answering support information database 140. Note that the answering support information reference level is a setting value (second predetermined similarity level) set by the administrator (see the region 512 described in FIG. 4).

In step S35, if a record is found in step S34 (step S35->YES), the question answering part 113 advances the process to step S36. If no record is found (step S35->NO), the question answering part 113 advances the process to step S37.

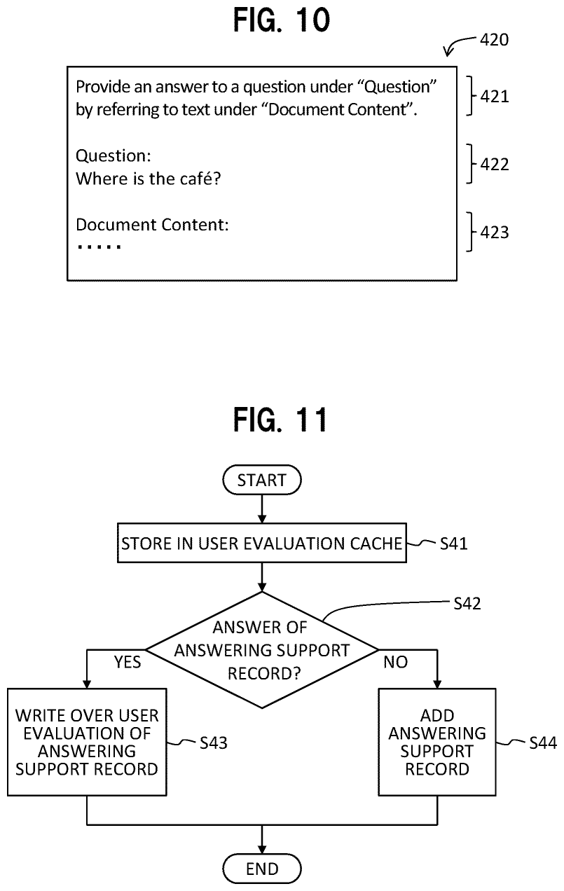

In step S36, the question answering part 113 generates an answer based on the document 145 of the record found in step S34 as a result of the process. More specifically, the question answering part 113 generates the answer by generating an answer generating prompt 420 (see FIG. 10, which will be described later), transmitting the answer generating prompt 420 to the language model server 210, and acquiring the answer.

FIG. 10 is a diagram showing the answer generating prompt 420 according to the present embodiment. An element 421 of the answer generating prompt 420 includes an instruction to create an answer to a question in an element 422 based on document content in an element 423. The element 422 shows the question issued by the user. The element 423 shows content of the document indicated by the document 145.

Returning to FIG. 9, description of the answer acquiring process will be continued.

In step S37, the question answering part 113 generates an answer based on a document having the highest level of similarity to the question issued by the user among documents in the document database 130 as a result of the process. More specifically, the question answering part 113 generates the answer by generating an answer generating prompt 420 (see FIG. 10), transmitting the answer generating prompt 420 to the language model server 210, and acquiring the answer. Note that the element 423 of the answer generating prompt 420 shows content of the document having the highest level of similarity to the question issued by the user.

As described above, the question answering device 100 includes a question answering part 113 that refers to answering support information (see the answering support information database 140) in which a question 143 and an answer 144 to the question 143 are stored in association with each other, and outputs, as an answer to a question issued by a user (a user issued question), an answer 144 corresponding to a question 143 that is in the answering support information and whose level of similarity to the question issued by the user (the user issued question) is greater than or equal to a first predetermined similarity level.

When there is a question 143 in the answering support information whose level of similarity to the question issued by the user is greater than or equal to the first predetermined similarity level, and an evaluation value (see the evaluation 146) of an answer 144 corresponding to the question 143 is greater than or equal to a predetermined evaluation value, the question answering part 113 outputs the answer 144 as an answer to the question issued by the user (see step S33). When the evaluation value is less than the predetermined evaluation value, the question answering part 113 transmits a prompt including the question issued by the user (see the answer generating prompt 420) to a language model server 210 and acquires and outputs an answer to the question (see step S36, S37).

In a case where there is no question 143 whose level of similarity to the question issued by the user is greater than or equal to the first predetermined similarity level in the answering support information (see step S32->NO), when there is a question 143 whose level of similarity to the question issued by the user is greater than or equal to a second predetermined similarity level in the answering support information, and an evaluation value (see the evaluation 146) of an answer 144 corresponding to the question 143 is greater than or equal to the predetermined evaluation value (see step S35->YES), the question answering part 113 transmits a prompt including a document 145 relating to the question 143 and the question issued by the user (see the answer generating prompt 420) to the language model server 210, and acquires and outputs an answer to the question (see step S36).

Note that the second predetermined similarity level is lower than the first predetermined similarity level.

In the case where there is no question 143 whose level of similarity to the question issued by the user is greater than or equal to the first predetermined similarity level in the answering support information (see step S32->NO), when there is a question 143 whose level of similarity to the question issued by the user is greater than or equal to the second predetermined similarity level in the answering support information, and an evaluation value (see the evaluation 146) of an answer 144 corresponding to the question 143 is less than the predetermined evaluation value (see step S35->NO), the question answering part 113 transmits a prompt including a document having the highest level of similarity to the question issued by the user and the question issued by the user (see the answer generating prompt 420) to the language model server 210, and acquires and outputs an answer to the question (see step S37).

### User Evaluation Process

FIG. 11 is a flowchart of the user evaluation process according to the present embodiment. Details of the user evaluation process (see step S27 shown in FIG. 7) will be described with reference to FIG. 11.

In step S41, the question answering part 113 stores the user evaluation received in step S26 (see FIG. 7) in the user evaluation cache 150.

In step S42, when the result of the answer acquiring process (see FIG. 9) of step S24 is an answer 144 in an answering support record (step S42->YES), the question answering part 113 advances the process to step S43. When the result of the answer acquiring process is not an answer 144 in an answering support record (step S42->NO), the question answering part 113 advances the process to step S44. What is meant by the processing result of the answer acquiring process being an answer 144 in an answering support record is that an answer 144 of a record has been used as the answer of the processing result in step S33 (see FIG. 9). What is meant by the processing result of the answer acquiring process not being an answer 144 in an answering support record is that an answer generated by using the language model server 210 in step S36, S37 has been used as the answer of the processing result.

In step S43, the question answering part 113 writes the user evaluation received in step S26 over an evaluation 146 of a record from which an answer has been acquired in step S33.

In step S44, the question answering part 113 adds a record to the answering support information database 140 (see FIG. 2). More specifically, the question answering part 113 adds a record to the answering support information database 140, and stores new identification information, the question issued by the user, and an answer which is the result of the answer acquiring process in the record. In addition, the answering support information generating part 112 stores, in the document 145 of the record, a name or identification information of the document (see the element 423 of the answer generating prompt 420 shown in FIG. 10) used for the answer generation. The evaluation 146 of the record becomes the user evaluation received in step S26.

As described above, the question answering part 113 acquires the evaluation value by the user on the outputted answer, and stores the evaluation value in the answering support information (see the evaluation 146 shown in FIG. 2) (see step S43, S44).

In the case where there is no question 143 whose level of similarity to the question issued by the user is greater than or equal to the first predetermined similarity level in the answering support information, the question answering part 113 transmits a prompt including the question issued by the user (see the answer generating prompt 420) to the language model server 210, acquires an answer to the question (see steps S36, S37), outputs the answer (see step S25), associates the question issued by the user and the outputted answer, and adds the question issued by the user and the outputted answer to the answering support information (see step S44).

### Answering Support Information Updating Process

FIG. 12 is a flowchart of the answering support information updating process according to the present embodiment. A process of updating the answering support information database 140 will be described with reference to FIG. 12.

In step S51, when an update condition, which will be described later, is satisfied for the answering support information database 140 (step S51->YES), the answering support information updating part 114 advances the process to step S52. When the update condition is not satisfied (step S51->NO), the answering support information updating part 114 ends the answering support information updating process.

The update condition includes meeting (1) and (2) described below. (1) The user evaluations are stored up to the size of the user evaluation cache 150 (see FIG. 3). (2) A time-series change of the user evaluation satisfies a predetermined condition. The predetermined condition is, for example, that a variation in user evaluations decreases, and the user evaluation improves. The time-series change may be considered as a change in average or dispersion of user evaluations that are divided into a predetermined number of groups or divided into groups by a predetermined time period.

Consider a case where the user evaluations are split into three parts of equal numbers to obtain a first period, a second period, and a third period. The user evaluations may be split into three parts of equal period lengths. If the dispersion decreases over the first period, the second period, and the third period, it may be determined that a variation in user evaluation has decreased. When the average increases, it may be said that the user evaluation has improved. As the update condition, a condition on a decrease range or an increase range may be included.

In step S52, the answering support information updating part 114 displays the administrator screen 510 (see FIG. 4) on the administrator terminal 230. The administrator presses the “Start update” button or the “Do not update” button in the region 516 to instruct whether or not to permit an update.

In step S53, when the update is instructed (step S53->YES), the answering support information updating part 114 advances the process to step S54. When the update is instructed not to be carried out (step S53->NO), the answering support information updating part 114 ends the answering support information updating process.

In step S54, the answering support information updating part 114 determines documents for the update. The answering support information updating part 114 calculates a score S3 as follows for each document and determines documents for the update.

S1=(a total number of records that are associated with the document and whose generation method 142 is “B”)/(a total number of records whose generation method 142 is “B”)

S2=(the maximum value of the evaluation 146)/(an average of the evaluations 146 of records that are associated with the document)

$$S 3 = S 1 \times S 2$$

Here, a record that is associated with a document is a record in which the document 145 is this document. The score S1 of a document indicates a proportion of a number of questions relating to the document. The score S2 indicates how low the evaluation relating to the document is (the lower the evaluation is, the larger the score S2 is).

The answering support information updating part 114 determines a predetermined proportion of documents that have higher S3 scores among all the documents as the documents for the update. The answering support information updating part 114 may determine documents whose S3 scores are greater than or equal to a predetermined value as the documents for the update. Alternatively, the answering support information updating part 114 may determine documents whose S1 scores are greater than or equal to a predetermined value or documents whose S2 scores are greater than or equal to a predetermined value as the documents for the update.

In step S55, the answering support information updating part 114 starts a process of repeating steps S56 and S57 for each of the documents for the update, which have been determined in step S54. Each individual document for the update, which is to be subjected to the repeating process, may be referred to as a processing target document below.

In step S56, the answering support information updating part 114 regenerates the answer 144 of a record in which the document 145 is a processing target document and the evaluation 146 is less than a predetermined value. The predetermined value may be the predetermined evaluation value (see step S31, S34 shown in FIG. 9).

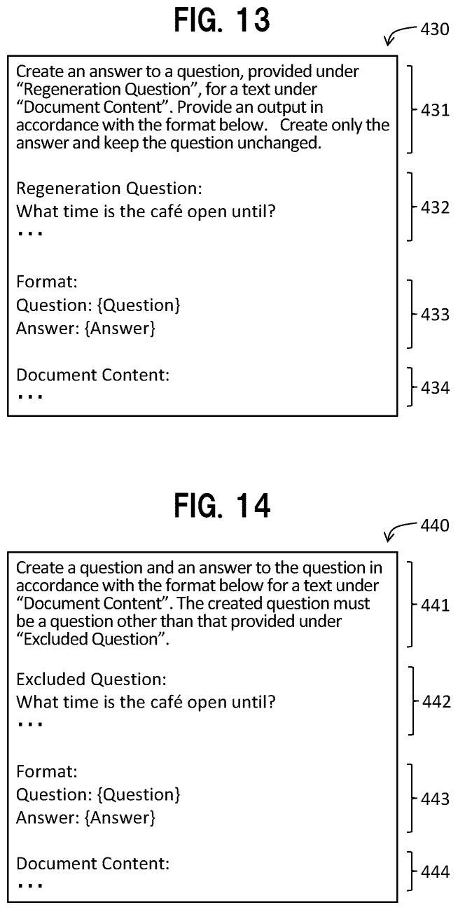

FIG. 13 is a diagram showing an answer regenerating prompt 430 according to the present embodiment. The answering support information updating part 114 regenerates an answer by using the answer regenerating prompt 430. An element 431 of the answer regenerating prompt 430 includes an instruction to create an answer to a question in an element 432 in accordance with a format in an element 433, based on a document content in an element 434. The element 432 includes the question 143 of a record in which the document 145 is a processing target document and the evaluation 146 is less than the predetermined value. The element 433 shows a format in which a question and an answer are outputted in separate rows. The element 434 shows the processing target document.

Returning to FIG. 12, description of step S56 will be continued. The answering support information updating part 114 transmits the answer regenerating prompt 430 to the language model server 210, and acquires a question and an answer. Subsequently, the answering support information updating part 114 updates the answer 144 of a record in which the question 143 is the acquired question to the acquired answer. In addition, the answering support information updating part 114 sets the generation method 142 of the record to “A” and the evaluation 146 of the record to “NE”.

In step S57, the answering support information updating part 114 adds an answering support information record. FIG. 14 is a diagram showing a question answer adding prompt 440 according to the present embodiment. The answering support information updating part 114 adds a question and an answer by using the question answer adding prompt 440. An element 441 of the question answer adding prompt 440 includes an instruction to create, based on a document content in an element 444, a question that is different from a question in an element 442 and an answer to the created question in accordance with a format in an element 443. The element 442 includes the following: the question 143 of a record in which the document 145 is a processing target document and the evaluation 146 is greater than or equal to the predetermined value; and the question 143 of a record in which the answer 144 has been regenerated in step S56. The element 443 shows the format in which a question and an answer are outputted in separate rows. The element 444 shows the processing target document.

Returning to FIG. 12, description of step S57 will be continued. The answering support information updating part 114 transmits the question answer adding prompt 440 to the language model server 210, and acquires a question and an answer. Subsequently, the answering support information updating part 114 adds a record of the acquired question and answer. More specifically, the answering support information updating part 114 adds a record to the answering support information database 140, and stores new identification information and the acquired question and answer in the record. In addition, the answering support information updating part 114 stores a name or identification information of the processing target document in the document 145, and sets the evaluation 146 to “NE”.

In step S58, the answering support information updating part 114 clears the user evaluation cache 150 (see FIG. 3).

As described above, the question answering device 100 includes an answering support information updating part 114 that, for a first document among the documents in the answering support information (see the answering support information database 140), transmits a prompt including an instruction to generate a question and an answer relating to the first document (the question answer adding prompt 440) to the language model server 210, acquires a new question and answer, and adds the acquired question and answer to the answering support information to update the answering support information. The first document is a document for which a proportion of a number of the questions 143 relating to the document (see score S1) is greater than or equal to a first predetermined value, a document for which an average value of evaluation values (see the evaluation 146) relating to the document (see a reciprocal of the score S2) is less than or equal to a second predetermined value, or a document for which a quotient (see the score S3) obtained by dividing a proportion of a number of the questions 143 relating to the document by an average value of evaluation values relating to the document is greater than or equal to a third predetermined value.

The answering support information updating part 114 updates the answering support information when a time-series change of the evaluation value by a questioner on the answer 144 satisfies a predetermined condition.

The predetermined condition is a condition based on average values or dispersions of evaluation value groups into which time-series evaluation values (see the user evaluation cache 150) are divided. The evaluation value groups may be obtained by dividing the time-series evaluation values (see the user evaluation cache 150) by a predetermined length.

### Features of Question Answering Device

The question answering device 100 returns the answer 144 of a record in which the question 143 coincides with a question issued by the user (a level of similarity is greater than or equal to the first predetermined similarity level) among the questions 143 in the answering support information database 140. The question answering device 100 may return the answer 144 of the record when the evaluation 146 is high (greater than or equal to a predetermined evaluation value).

If there is no record in which the question 143 coincides with the question issued by the user, the question answering device 100 may generate an answer of the question issued by the user by using a document 145 of a record in which the question 143 has a high level of similarity to the question issued by the user (the level of similarity is greater than or equal to the second predetermined similarity level) among the questions 143 in the answering support information database 140, or a document having a high level of similarity to the question issued by the user. The question answering device 100 then returns the answer (see steps S36 and S37 shown in FIG. 9). In this way, the question answering device 100 may return an answer based on the answer 144 corresponding to the question 143 that is similar to the question issued by the user with a level of similarity greater than or equal to the first predetermined similarity level or based on the document 145 corresponding to the question 143 that is similar to the question issued by the user with a level of similarity greater than or equal to the second predetermined similarity level. For this reason, a highly accurate answer can be expected.

Further, the question answering device 100 may regenerate an answer having a low evaluation 146. Further, the question answering device 100 may generates an additional question and answer for a document relating to an answer for which a score of the evaluation 146 is low, or a document for which a large number of questions have been made, and updates the answering support information database 140 (see steps S56 and S57 shown in FIG. 12).

According to such a question answering device 100, the user (questioner) may obtain a highly accurate answer or an answer having high evaluation to a question. Further, the question answering device 100 may regenerate an answer having low user evaluation, and may add an additional question and answer for a document for which there is a large number of questions. In this way, it may be expected that the accuracies of answers are improved.

### Modification: Regeneration of Answering Support Information Having Low Evaluation

In the above-described embodiment, the answering support information updating part 114 determines documents for the update by calculating scores of documents (see step S54), and regenerates the answer 144 of an answering support record in which the evaluation is low (see step S56). The answering support information updating part 114 may regenerate an answer 144 having low evaluation irrespective of documents. For example, the answering support information updating part 114 may regenerate an answer 144 by using the answer regenerating prompt 430 (see FIG. 13) including the document 145 for a record in which the evaluation 146 is less than a predetermined evaluation value.

As describe above, the question answering device 100 includes an answering support information updating part 114 that, for a question 143 for which the evaluation value (see the evaluation 146) is less than a predetermined evaluation value in the answering support information (see the answering support information database 140), transmits a prompt including the question 143 and a document 145 relating to the question 143 (the answer regenerating prompt 430) to the language model server 210, acquires an answer to the question 143, and updates the answer 144 to the question 143 in the answering support information to the acquired answer.

### Other Modifications

Although some embodiments of the disclosure have been described above, these embodiments are merely examples, and do not limit the technical scope of the disclosure. The disclosure may take various other embodiments. Various modifications such as omission or replacement may be made without departing from the gist of the disclosure. These embodiments and modifications are encompassed in the scope and gist of the disclosure described in the present Specification, and are encompassed in the scope of the Claims and their equivalents.

### Hardware Configuration

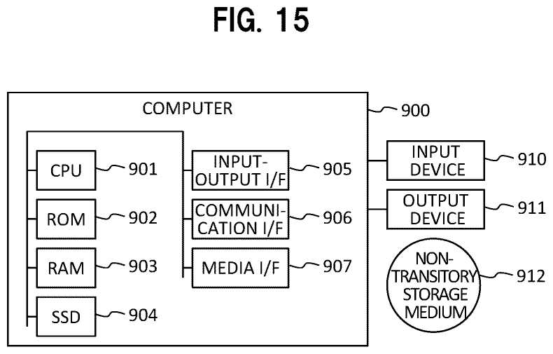

The question answering device 100 according to the above-described embodiment may for example be achieved by a computer 900 with a configuration as shown in FIG. 15. FIG. 15 is a hardware configuration diagram showing an example of the computer 900 that achieves the functions of the question answering device 100 according to the above-described embodiment. The computer 900 includes a CPU 901, a ROM 902, a RAM 903, an SSD 904, and an input-output interface 905 (described as INPUT-OUTPUT I/F [Interface] in FIG. 15). The computer 900 further includes a communication interface 906 (described as COMMUNICATION I/F in FIG. 15) and a media interface 907 (described as MEDIA I/F in FIG. 15). The computer 900 may include a hard disc drive (an HDD) in place of the SSD 904, or may further include an HDD in addition to the SSD 904.

The CPU 901 operates based on a program stored in the ROM 902 or the SSD 904, and performs control by the controller 110 of FIG. 1. The ROM 902 stores therein a boot program which is executed by the CPU 901 at start-up of the computer 900, a program relating to hardware of the computer 900, or the like.

The CPU 901 controls an input device 910, such as a mouse or a keyboard, and an output device 911, such as a display or a printer, via the input-output interface 905. The CPU 901 acquires data from the input device 910, and outputs generated data to the output device 911, via the input-output interface 905.

The SSD 904 stores a program to be executed by the CPU 901 and data to be used by the program or the like. The communication interface 906 receives data from another device (for example, the language model server 210), which is not shown, via a communication network and outputs the data to the CPU 901. Further, the communication interface 906 transmits data generated by the CPU 901 to another device via the communication network.

The media interface 907 reads a program or data stored in a non-transitory storage medium 912, and outputs the program or data to the CPU 901 via the RAM 903. The CPU 901 loads a program from the non-transitory storage medium 912 and on the RAM 903 via the media interface 907, and executes the loaded program. The non-transitory storage medium 912 may be an optical storage medium such as a digital versatile disk (DVD), a magneto-optical storage medium such as a magneto-optical disk (MO), a magnetic storage medium, a conductive memory tape medium, a semiconductor memory, or the like.

For example, in a case where the computer 900 functions as the question answering device 100 according to the above-described embodiment, the CPU 901 of the computer 900 executes the program 128 (see FIG. 1) loaded on the RAM 903 to achieve the functions of the question answering device 100. The CPU 901 reads a program from the non-transitory storage medium 912 and executes the program. In one or more embodiments, the CPU 901 may read a program from another device via the communication network, or may install the program 128 from the non-transitory storage medium 912 into the SSD 904, and execute the program 128.

An object of an embodiment of the disclosure is to provide a question answering device and a question answering method that enable a highly accurate answer to a question.

According to an embodiment, it is possible to provide a question answering device and a question answering method that enable a highly accurate answer to a question. An object, a configuration, and an effect other than those described above are revealed by the following description of embodiments.

What is claimed is:

1. A question answering device, comprising:
a hardware processor configured to:
refer to answering support information in which a question and an answer to the question are stored in association with each other; and
output the answer corresponding to the question that is in the answering support information and whose level of similarity to a user issued question is greater than or equal to a first predetermined similarity level, as an answer to the user issued question,
wherein the user issued question is a question issued by a user.

2. The question answering device according to claim 1,
wherein when there is no question whose level of similarity to the user issued question is greater than or equal to the first predetermined similarity level in the answering support information, the hardware processor is configured to:
transmit a prompt including the user issued question to a language model server, and acquire and output an answer to the user issued question; and
add the user issued question and the outputted answer in association with each other to the answering support information.

3. The question answering device according to claim 2,
wherein in the answering support information, an evaluation value by the user on the answer is further associated and stored,
wherein the hardware processor is configured to acquire an evaluation value by the user on an outputted answer and store the acquired evaluation value in the answering support information,
wherein when there is a question in the answering support information whose level of similarity to the user issued question is greater than or equal to the first predetermined similarity level, and an evaluation value on an answer corresponding to the question is greater than or equal to a predetermined evaluation value, the hardware processor is configured to output the answer as an answer to the user issued question, and
wherein when the evaluation value on an answer corresponding to the question is less than the predetermined evaluation value, the hardware processor is configured to transmit a prompt including the user issued question to the language model server, and acquire and output an answer to the question.

4. The question answering device according to claim 3,
wherein in the answering support information, a document relating to the question is further associated and stored,
wherein when there is no question whose level of similarity to the user issued question is greater than or equal to the first predetermined similarity level in the answering support information,
when there is a question in the answering support information whose level of similarity to the user issued question is greater than or equal to a second predetermined similarity level, and an evaluation value on an answer corresponding to the question is greater than or equal to the predetermined evaluation value, the hardware processor is configured to:
transmit a prompt including a document relating to the question and the user issued question to the language model server, and acquire and output an answer to the question, and
wherein the second predetermined similarity level is lower than the first predetermined similarity level.

5. The question answering device according to claim 4,
wherein when there is no question whose level of similarity to the user issued question is greater than or equal to the first predetermined similarity level in the answering support information,
when there is a question in the answering support information whose level of similarity to the user issued question is greater than or equal to the second predetermined similarity level, and an evaluation value on an answer corresponding to the question is less than the predetermined evaluation value, the hardware processor is configured to:
transmit a prompt including a document having the highest level of similarity to the user issued question and the user issued question to the language model server; and
acquire and output an answer to the question.

6. The question answering device according to claim 1,
wherein in the answering support information, an evaluation value by the user on the answer and a document relating to the question are further associated and stored,
wherein the hardware processor is configured to:
acquire an evaluation value by the user on an outputted answer and store the acquired evaluation value in the answering support information, and
wherein, for a question in the answering support information for which the evaluation value is less than a predetermined evaluation value, the hardware processor is configured to:
transmit a prompt including the question and a document relating to the question to the language model server, and acquire an answer to the question; and
update the answer to the question in the answering support information to the acquired answer.

7. The question answering device according to claim 1,
wherein in the answering support information, an evaluation value by the user on the answer and a document relating to the question are further associated and stored,
wherein the hardware processor is configured to:
acquire an evaluation value by the user on an outputted answer and store the acquired evaluation value in the answering support information,
wherein, for a first document among documents in the answering support information, the hardware processor is configured to:
transmit a prompt including an instruction to generate a question and an answer relating to the first document to a language model server to acquire a new question and answer; and
add the acquired question and answer to the answering support information to update the answering support information, and
wherein the first document is:
a document for which a proportion of a number of questions relating to the document is greater than or equal to a first predetermined value;
a document for which an average value of evaluation values relating to the document is less than or equal to a second predetermined value; or
a document for which a quotient obtained by dividing a proportion of a number of questions relating to the document by an average value of evaluation values relating to the document is greater than or equal to a third predetermined value.

8. The question answering device according to claim 6,
wherein the hardware processor is configured to update the answering support information when a time-series change of the evaluation value by a questioner on the answer satisfies a predetermined condition.

9. The question answering device according to claim 8,
wherein the predetermined condition is a condition based on an average value or a dispersion of each evaluation value group, and
wherein said each evaluation value group is obtained by dividing a chronology of the evaluation values into groups by a predetermined length.

10. A question answering method for a question answering device, the method comprising:
referring to answering support information in which a question and an answer to the question are stored in association with each other; and
outputting the answer corresponding to the question that is in the answering support information and whose level of similarity to a user issued question is greater than or equal to a first predetermined similarity level, as an answer to the user issued question,
wherein the user issued question is a question issued by a user.
